(19) United States
(12) Patent Application Publication
(10) Pub. No.: US 2005/0106747 A1
(43) Pub. Date: May 19, 2005

(54) Automatic blood analysis and identification system

(76) Inventors: Sam M. Chaoui, Diamond Bar, CA (US); Walter M. Mosher JR., West Hills, CA (US); Mark M. Kotik, Taylor, MI (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/958,984

(22) Filed: Oct. 4, 2004

Related U.S. Application Data
(63) Continuation-in-part of application No. 10/616,892, filed on Jul. 9, 2003.

(51) Int. Cl. G01N 21/00

(52) U.S. Cl. 436/165

(57) ABSTRACT

An automatic blood analysis and identification process permits patient identification and other vital information to be automatically printed directly on a container holding a sample of a body fluid sample almost immediately after the sample has been drawn and analyzed. There is no manual handling of the sample between the draw and the identification. The process for analyzing the body fluid includes placing the body fluid sample in a container which is placed in a fluid analyzing unit. The sample is analyzed to determine characteristics of the body fluid which are then transferred to the container. The system may utilize radio frequency identification (RFID) technology to communicate electronic data bearing the information to an RFID inlet associated with the container.

### RELATED APPLICATION

This application is a continuation-in-part of U.S. patent application Ser. No. 10/616,892, filed on Jul. 9, 2003.

### BACKGROUND OF THE INVENTION

The present invention generally relates to blood analysis techniques. More particularly, the present invention relates to an automatic blood analysis and identification system.

There is a great need for accurate, efficient analysis and identification of samples of bodily fluids. A particularly important need for such analysis occurs in hospital and medical settings. Blood samples may be drawn for many reasons, including the testing of donated blood for blood type, Rh factor, HIV infection, etc. Prior to analysis, blood samples are drawn from a patient and placed in a container, such as a test tube. A label may be placed on the tube by hand and identifying information relating to the source of the sample may be handwritten on the label. The identification information may include a patient's name, patient number, etc.

While this has been useful to identify samples, some hospitals and medical clinics have experienced problems correlating samples with the results of tests on those samples, etc. due to mislabeling and clerical errors in the handling of such routine matters. These errors can result in the dispensing of the wrong blood to a patient undergoing a procedure, either because the patient's blood type was misidentified and/or the blood type/Rh factor of donor blood was misidentified.

The current (manual) blood draw process involves a great deal of human interaction and, consequently, creates the possibility of human error. Based on doctor's orders, a nurse selects the necessary vacuum blood containers to withdraw blood from a patient. The varieties of vacuum blood containers is based on a number of factors, including blood draw volume, reagents within the container necessary for tests specified by the physician, and the size of vacuum container required.

A fresh tube is selected that has needles on both ends—one to be inserted in the patient's arm and the other needle to pierce the rubber stopper of the vacuum container. The tube also has a manual clamp in order to stanch the blood flow. The nurse also picks up a fresh vacuum container holder, which facilitates the swapping of vacuum containers when drawing multiple samples. One of the needles at the end of the blood draw tube is inserted into the holder and is held in place by an automatic snap. The other needle at the opposite end of the tube is inserted into the patients arm and the clamp is closed to prevent blood flow. The first vacuum container can now be inserted into the holder. It is held in place by automatic snap. During the insertion, the needle previously inserted into the holder automatically pierces the rubber stopper.

The nurse releases the clamp in order to allow blood to be drawn into the vacuum container. When the blood stops flowing into the vacuum container, the nurse closes the clamp in order to prevent further blood flow. The filled vacuum container can now be pulled out of the holder. If prescribed by the reagent within the vacuum container, the nurse immediately mixes the blood and reagent by flipping the container upside down the prescribed number of times. The next vacuum container can now be inserted into the holder for an additional blood sample. The process repeats until all prescribed vacuum containers are filled. The nurse then identifies the blood samples according to the hospital's procedure(s).

Many different types of apparatus have been employed to analyze bodily fluids such as blood cells. Blood analysis devices are commonly used in hospital settings to identify the characteristics of a blood sample, such as blood type, Rh factor, platelet count, glucose levels, etc. When a number of characteristics of each blood cell are to be analyzed, blood analyzers are often employed. However, blood analysis systems may also be large, bulky and require that bodily fluids be placed on a slide prior to analysis. For example, U.S. Pat. No. 5,209,903 discloses a large-scale blood analysis system that includes multiple racks with each rack holding multiple samples of bodily fluids. However, before samples can be analyzed, the samples must be taken from sample containers and smeared onto slides. This system is not practical for situations that require immediate results and, due to its relatively large size, would not be able to fit into a small medical office or emergency room.

While methods such as those described above may provide means of analyzing samples of bodily fluids, such methods can always be improved to provide better correlation of samples with results by reducing the handling of the samples prior to, during, and after analysis.

Accordingly, there is a need for a blood analysis system that reduces human error factors related to mislabeling/misidentification of blood samples. What is also needed is blood analysis system that reduces human error factors related to mislabeling/misidentification of donors. There is a further need for a blood analysis system that is automatic. There is an additional need for a blood analysis system that is relatively compact in size and inexpensive. The present invention satisfies these needs and provides other related advantages.

### SUMMARY OF THE INVENTION

A process for analyzing a bodily fluid is illustrated and described that reduces human error factors related to the mislabeling or misidentification of blood type. This process system is usable in any situation where body fluids are analyzed and labeled, including, for example, situations where donor blood samples are analyzed and labeled for type, Rh factor, and donor identification. These situations can occur anywhere there is a need to analyze blood, such as hospitals, blood banks, blood-donation organizations, research labs, crime labs, or the like.

A process for analyzing a body fluid includes placing a sample of the body fluid in a container. The container is placed in a fluid analyzing unit either prior to or after the sample is placed in the container (usually via a blood draw if the body fluid being analyzed is blood). The sample is then analyzed to determine one or more characteristics of the body fluid. In the case of a blood sample, the characteristics to be determined may include blood type, Rh factor, etc. These determined characteristics are then transferred to the container so that the container alone can provide information relating to the characteristics once the container is removed from the fluid analyzing unit. In order to accomplish this, the determined characteristics may be placed directly on the container or on a label affixed to the container (either prior to or after the determined characteristics are placed on the label).

Body fluid source identifying data (e.g., donor information, the date the sample was taken, where the sample was taken, or the like) is communicated to the fluid analyzing unit, and the body fluid source identifying data is also printed on the container. The body fluid source identifying data, as well as the determined characteristics, may be printed directly on the container or onto a label which is affixed to the container, either prior to or after the body fluid source identifying data and determined characteristics are printed on the label.

The body fluid source identifying data may also be communicated to a radio frequency identification (RFID) inlet associated with the container. The RFID inlet may incorporated into the container itself or a label affixed to the container. The determined characteristics are printed on the label having the RFID inlet or directly on the container. The label having the RFID inlet may be affixed to the container, either prior to or after body fluid source identifying data and/or determined characteristics are printed on the label. The determined characteristics are also communicated to the RFID inlet.

The body fluid source identifying data may also be communicated to the container via a barcode printer. A barcode associated with the body fluid source identifying data may be printed onto a label either prior to or after the label is affixed to the container. The determined characteristics may also be communicated to the container via the barcode printer and a barcode associated with the determined characteristics printed onto the label either prior to or after the label is affixed to the container.

The process provides better correlation of samples with results and reduce errors by having the blood analysis system directly label the sample containers. Thus, human error factors related to mislabeling/misidentification of the source of blood samples and in the handling of the samples prior to, during, and after analysis may be reduced. The blood analysis system is automatic, relatively compact in size and inexpensive.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a top plan view of a blood analysis and identification system embodying the present invention;

FIG. 2 is a front elevational view of the blood analysis and identification system of FIG. 1;

FIG. 3 is a schematic view showing the mutual communication between a reader and the carrier unit of the invention; and

FIG. 4 is a schematic view showing the mutual communication between a reader within the carrier unit and the container of the invention

FIG. 5 is a flowchart illustrating a process for analyzing a blood sample, in accordance with the present invention.

### DETAILED DESCRIPTION OF THE PREFERRED EMBODIMENT

The present invention is useful in a variety of applications involving analysis of bodily fluids, such as testing for glucose levels, platelet count, urine analysis, and, in particular, blood type and Rh factor. It provides a means to provide better correlation of samples with results and reduce errors by having the blood analysis and identification system directly label the sample containers. This reduces human error factors related to mislabeling/misidentification of the source of blood samples and in the handling of the samples prior to, during, and after analysis and provides a blood analysis system that is automatic, relatively compact in size and inexpensive. The system can identify blood samples, automatically and without error, to a specific patient. The system is intended to identify and analyze blood from a single person at a time.

A process and system for analyzing a bodily fluid are illustrated and described that reduce human error factors related to the mislabeling or misidentification of blood type. This system is usable in any situation where blood samples are analyzed and labeled for type, including situations where donor blood samples are analyzed and labeled for type, Rh factor, and donor identification. These situations can occur anywhere there is a need to analyze blood, such as hospitals, blood banks, blood-donation organizations, research labs, crime labs, or the like.

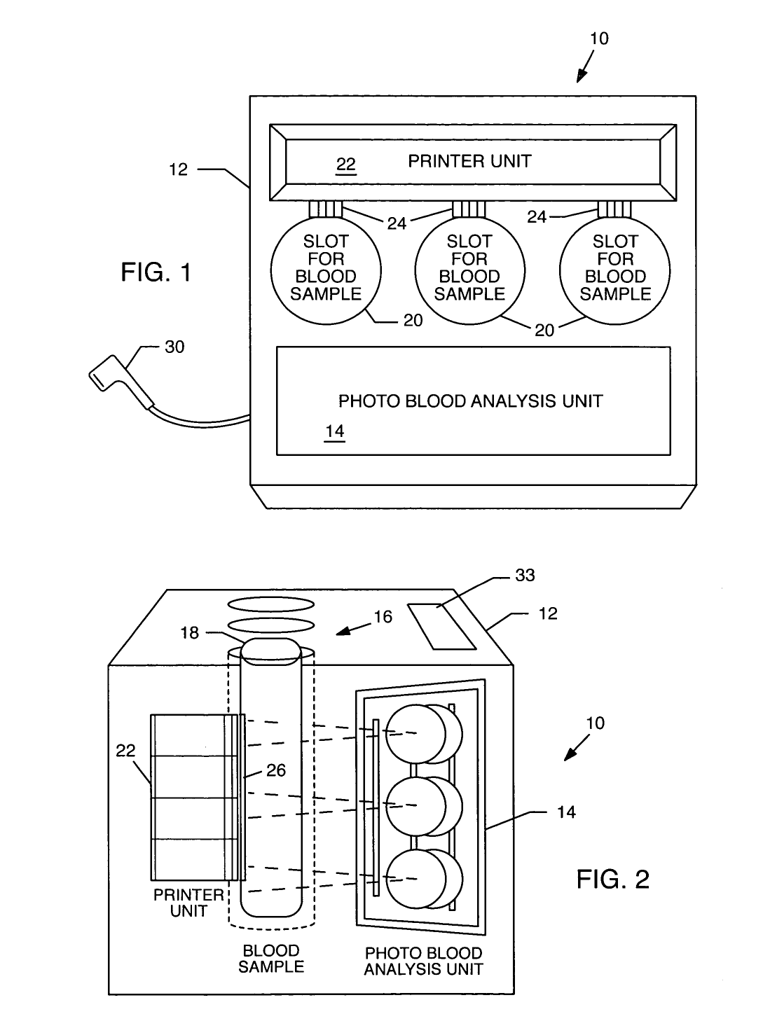

As shown in the drawings for purposes of illustration, the present invention resides in an automatic blood analysis system. With reference to FIGS. 1-5, a blood analysis system 10 includes a single or multi-sample carrier bodily fluid analysis and identification unit (or carrier unit) 12 that encloses a photo (light) blood analysis unit, such as an optical or photo-analyzer 14, that determines characteristics of a sample of a bodily fluid. For example, an analysis of a blood sample can determine various characteristics of the blood, such as blood type and/or Rh factor.

The carrier unit 12 also includes a means 16 for holding at least one sample container 18, in the form of a conventional vacuum container or vacutainer, within the carrier unit 12, such as at least one slot 20 located on a surface of the carrier unit 12 although a plurality of slots 20 are preferred such that multiple samples from the same individual can be identified concurrently. For example, the carrier unit 12 illustrated in FIGS. 1 and 2 includes three slots 20 and each slot 20 is capable of holding a single container 18. The slots 20 of a particular carrier unit 12 may come in a variety of sizes so that the carrier unit 12 is able to accommodate sample containers 18 of various sizes. The number of slots 20 in a particular unit 12 may vary. For example, some units 12 may only have one slot 20 while other units 12 have two, three, four slots 20 and so on.

The carrier unit 12 further includes a printer 22 for printing human and machine readable text. The printer 22 is electrically, electronically, and mechanically connected to various components within the carrier unit 12. The printer 22 is located within the carrier unit 12 adjacent to the slot(s) 20. One side of each slot 20 is open to the printer 22 and allows the printer 22 to print the information on the container 18 located within the slot 20. The printer 22 includes at least one printer head 24 such that the printer head 24 prints information on each container 18. Each container 18 may be indexed to the printer head 24 of the printer 22, although each slot 20 may be assigned its own printer head 24 if the printer 22 has multiple printer heads. The printer 22 may be selected from one of several types, including impact printers (e.g., dot matrix, typewriter-like imprint), ion deposition printers, ink jet printers, laser printers, direct thermal printers, and thermal transfer printers. Identification information may also be printed directly on the containers 18 by laser etching. If direct thermal printing is used, an imaging coating must be provided on any label 26 attached to the container 18. The label 26 may include an adhesive surface that allows the label 26 to be attached to the container 18. The printer 22 may also serve as a label printer and label applicator that prints and applies a label 26 containing patient information onto the container 18. Information, including but not limited to body fluid source identifying data and/or the determined characteristics of the body fluid, may be placed on the label 26 either prior to or after the label 26 is placed on the container 18 by the printer 22.

The sample container 18 may be made of transparent (clear or colored) glass or plastic. Each sample container 18 includes printable surfaces (or surfaces to which printable labels 26 can be attached) along the side(s) of the container 18. The containers may be pre-loaded into the carrier unit 12 prior to the blood sample being drawn. Once the blood sample is drawn into the container(s) 18, and the photo-analysis conducted, the results of the photo-analysis are conveyed to the internal printer 22, which then imprints the determined characteristics and/or identification of the source of the sample directly onto the side of the sample container(s) 18 or their attached labels 26. The sample container(s) 18 may also have an RFID inlet or receiver (i.e., chip & antenna) 28 attached, with the donor/blood type and/or patient identification data also written to the RFID inlet 28 as well as the imprint on the side of the container 18 or on the label 26 attached to the side of the container 18. Alternatively, the blood samples may be drawn into the containers 18 prior to the placement of the containers 18 in the carrier unit 12.

The RFID inlet 28 may be attached to the container 18, either by being embedded within the container 18 or attached to the container 18 by an adhesive or the like either prior to or after the body fluid source identifying data and/or the determined characteristics are imparted to the RFID inlet 28. Alternatively, the RFID inlet 28 may be embedded within the label 26 shown in FIG. 2 during the manufacture of the label 26. Body fluid source identifying data and the determined characteristics of the body fluid may be written to the RFID inlet 28 on the label 26 either prior to or after the label 26 is attached to the container 18.

A control unit (not shown) coordinates and controls the functions of each sub-system in the carrier unit 12, such as the printer 22 or photo-analyzer 14. The control unit is located within the carrier unit 12 and is also electrically, mechanically, and electronically connected to each of the sub-systems (photo-analyzer 14, printer 22, etc.) as well as to a display/user interface (not shown) located on the carrier unit 12. The user interface allows a user to program and operate the carrier unit 12. The user interface may come in several forms including, without limitation, a graphical user interface, liquid crystal display, knobs, dials, switches, buttons or the like. The control unit includes a digital computer that has a processor and a memory. A computer program stored within the memory includes at least one program, executed by the processor, which operates the analysis and printing functions when the processor receives electrical signals from the photo-analyzer 14 corresponding to blood type and/or Rh factor, as well as identification information based on a barcode scan or RFID scan. The information may be input manually to the carrier unit 12 as well via the user interface.

At least one software program is stored in the memory to be operated on by the processor within the control unit. This program may include a first sub-routine for operating the photo-analyzer 14 and determining the blood type and/or Rh factor of a blood sample in the carrier unit 12. The program may also include a second sub-routine for printing information, such as blood type and/or Rh factor, on the sample container 18 holding the blood sample. The program may further include a third sub-routine for receiving information transmitted to the carrier unit 12 via RFID or barcode reader technology. A bar code reader or scanner 30 is electrically, electronically, and mechanically connected to the control unit such that the reader 30 is able to scan a barcode associated with a particular patient so that the information can be stored in the control unit. Information relating to that particular barcode may have already been downloaded to the carrier unit 12 so that the control unit is able to correlate the scanned barcode with particular information. The control unit may then associate that particular barcode with a particular sample container 18 located in one of the slots 20 of the carrier unit 12. The control unit may later direct the printer 22 to print that particular barcode on that particular container 18. In addition to printing the barcode associated with a particular patient on the container (i.e, body fluid source identifying data), the printer 22 prints a barcode associated with the determined characteristics of the body fluid on the container 18.

The photo-analyzer 14 analyzes a blood sample within the container 18, and electronically sends information regarding the determined characteristics of the blood sample, such as blood type and Rh factor, to the printer 22 via the control unit. The blood sample information is associated with the patient's identification information and stored in the memory of the control unit. The photo-analyzer 14 illustrated in FIG. 2 includes a detector, three scanners, and three scanning beams passing through a container 18 holding a blood sample. The number of scanners and scanning beams may vary depending on the particular photo-analyzer 14 used. Each slot 20 may be assigned a particular set of scanning beams or a single set of scanning beams may be used for every slot 20 in the carrier unit 12.

Prior to photo-analysis of the blood sample, identification data associated with the source of the sample (such as a blood donor) may be communicated to the carrier unit 12 via RFID or the barcode reader technology, as discussed above. Alternatively, other possible methods of communicating identification data to the unit 12 include voiceprint, retinal scan, and fingerprints. All identification data (e.g., patient/donor name, identification number, etc.) and determined characteristics (e.g., blood type, Rh factor, etc.) of the blood sample may be printed onto the sample container 18 by the printer 22. In addition to the imprinted identification data, the printer 22 may also print a Barcode imprint on the container 18 or store RFID data on a chip on the container 18.

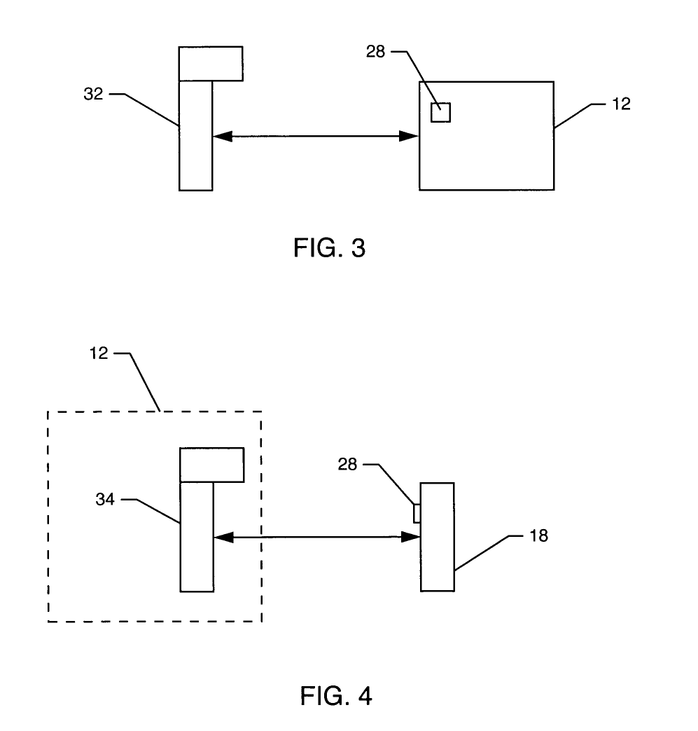

The mutual communication between an RFID reader 32 and the carrier unit 12 is illustrated in FIG. 3 of the drawings. Initially, the RFID circuitry of the reader 32 is programmed to provide identifying and other information and the carrier unit 12 is capable of eliciting such information from the RFID circuitry of the reader 32. The identifying data may include patient name, patient number, etc. The carrier unit 12 may then use the printer 22 to print this identifying data on the container 18 at any time during the process, including printing the patient number on the container 18 in barcode form. In a read/write configuration of the circuitry of the carrier unit 12, the reader may also impart information to, alter information on, or delete information from the carrier unit 12. Likewise, the carrier unit 12 is capable of providing identifying and other information to the RFID circuitry of each container 18, as shown in FIG. 4 which illustrates the mutual communication between an RFID reader 34 in the carrier unit 12 and a container 18. The carrier unit 12 also provides the determined characteristics of the sample within a particular container to the RFID circuitry of that particular container 18.

The carrier unit may also include a user interface 33 which includes a display (such as a liquid crystal display), a thumb print reader, alpha-numeric keypad, and/or various knobs, switches, and controls used to activate/operate the carrier unit 12. The display could employ touchscreen technology that would eliminate the need for physical switches, keypads, or the like.

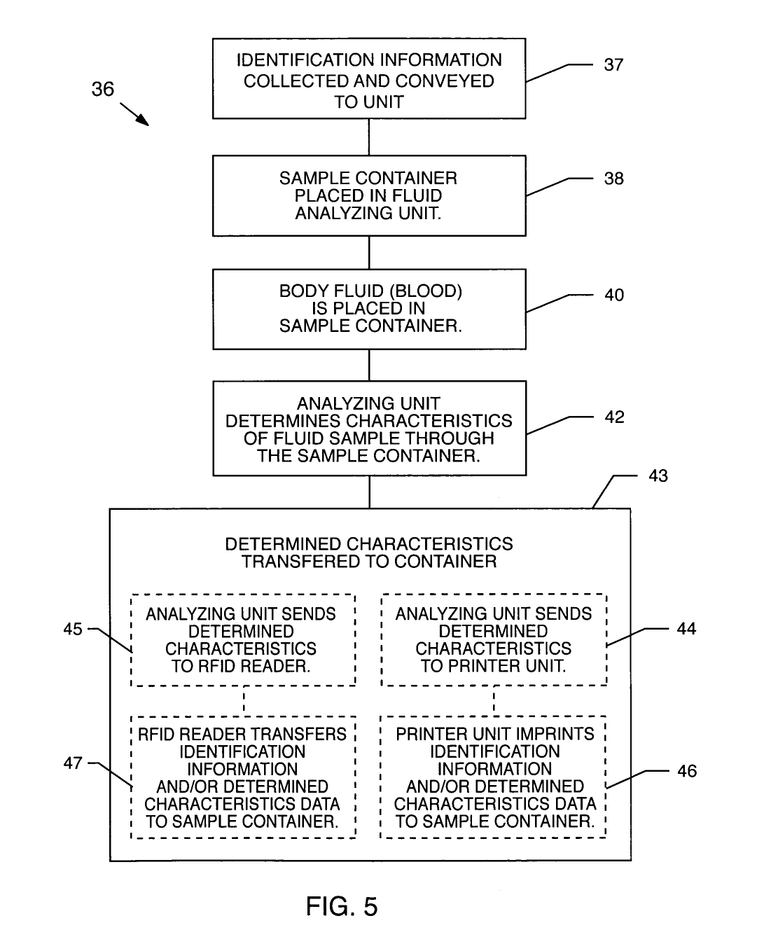

In use, as illustrated in FIG. 5, identification information may be conveyed to the carrier unit 12 before analysis of a bodily fluid begins. Identification information may be conveyed in several ways including, but not limited to, direct input from a technician, a bar code assigned to and/or printed on a wristband attached to the patient that can be read by the unit 12, an RFID transport medium on the patient that can be read by the unit 12, and patient biometric information (including, but not limited to, a retinal scan, fingerprint scan, and voice print).

The process of entering identification information which can be printed on the container(s) 18 can begin at a hospital check-in desk or admittance station. At the hospital admittance station, patient enrollment or return patient verification occurs (i.e., the patient arrives at the hospital check-in center and provides pertinent information). The patient may be asked to do a number of things to verify identification. The patient may be asked to place his or her finger or thumb on a patient identification pad in the form of a fingerprint reader in order to obtain a digitized fingerprint. Digitized fingerprint information may then be written to an RFID wristband that is printed out for the patient on the spot. The patient will wear the RFID wristband during their hospital stay. The RFID wristband contains relevant hospital information along with the patient's personal identification information (e.g., their digitized finger print information). With the RFID wristband on the patient's wrist, there is decreased risk of a patient switching wristbands with another patient and/or being misidentified. The digitized finger print on the RFID wristband must always match the actual finger print on the patient's hand.

The fingerprint information may be stored on the RFID chip of the wristband in the following manner. A fingerprint reader registers a patient's thumb or fingerprint. Electronics within the fingerprint reader reads the peaks and valleys of the fingerprint. The electronics identify the unique minutia and store the data as a file with the file size depending on the level of security desired. This information may then be then written to the RFID chip of the patient's wristband. Actual fingerprint data is discarded and the fingerprint cannot be recreated by the minutia data, hence there are no privacy issues.

After check-in, the patient can then be sent to his or her hospital room. In the room, identification verification may take place when blood or other bodily fluid is drawn. In the hospital room, blood or other bodily fluid may be drawn by a nurse and/or other medical practitioner. The blood may be drawn directly into the container(s) 18 already pre-loaded into the carrier unit 12 or the blood may alternatively be drawn into a container 18 that is then placed in a slot 20 of the carrier unit 12. Identification information may be downloaded or written to the carrier unit 12 prior to blood or any other bodily fluid being drawn using various technologies including, but not limited to, bar code and RFID technology. The carrier unit 12 is a stand alone unit that does not need to be networked or connected to the hospital IS system or any other system whereby information may be conveyed to the unit 12. The identification information imprinted on the wristband RFID chip provides the information that is downloaded to the carrier unit 12. All additional information that is eventually written to the RFID chip on the container 18 is determined by the carrier unit 12 during the analysis process. Alternatively, the identification information may be written to the unit 12 at the same time the information is written to the patient's RFID wristband at check-in if the unit 12 is networked to the hospital IS system. If the unit 12 is networked to the hospital IS system, the unit 12 receives constant updates of information. The unit 12 may be activated by confirmation of the patient's identification information. Such confirmation may occur via thumb print verification (i.e., a fingerprint reader built into the unit 12 that reads the patient's thumb print when placed on the reader), password verification (i.e., entering a password into the user interface of the unit 12), or RFID verification when data stored within the carrier unit 12 is matched with that stored on the RFID wristband worn by the patient either because the information on the RFID wristband was previously downloaded to the unit 12 or the unit 12 is connected to the hospital IS system. The unit 12 may also be programmed to activate upon being downloaded with new identification information. The unit 12 may also be manually activated. Another method of identification includes using the bar code scanner 30 to bar code scan the bar code that may be present on the patient's wristband and then matching the bar code on the patient's wristband to information stored within the carrier unit 12. Whichever method is used, if the identification information does not match, the blood analysis carrier unit 12 will not activate. In the event that blood is to be drawn directly into a container 18 already within the carrier unit 12, the carrier unit 12 will not allow blood to be drawn if the identification information does not match. In that event, the carrier unit 12 will also not allow information to be printed onto the vacuum container or written to the vacuum container 18 if RFID technology is being used.

The container 18 may be pre-loaded or placed in the slot 20 while still empty 38 and then directly filled with a bodily fluid while in the slot 20. The process for analyzing one or more bodily fluids 40 begins once a sample of a bodily fluid to be analyzed, such as blood, is placed in at least one container 18, pre-loaded. The container 18, depending on its size, will be placed in a slot 20 large enough to accommodate its size. The label 26 may be affixed to the container 18 either prior to or after the body fluid identifying data is transferred to the label 26.

Data which identifies a source of the blood may be communicated to the carrier unit 12 prior to analyzing the blood sample. Data identifying the source of the blood sample may be communicated to the carrier unit 12 via RFID or bar code reader technology, as outlined above. This identifying data may then be printed on the container 18, prior to, during or after the analysis.

The blood sample is then analyzed 42 to determine characteristics of that particular bodily fluid. The photo analyzer 14, reading through the material of the container 18, analyzes the sample to determine the characteristics of the blood sample. As stated above, these determined characteristics may include blood type, Rh factor, etc. If several blood samples are in different containers 18 in the unit 12, once one of the samples is analyzed for type and Rh factor, the other samples need not be analyzed as they will presumably be identified since they come from the same individual. The determined characteristics are then transferred 43 to the container 18. The determined characteristics, as well as the body fluid source identifying date, can be transferred to the container 18 in a number of ways including, without limitation, by printing human readable text on the container 18, printing machine readable text (e.g., bar code) on the container 18 or by transmission to the RFID inlet 28. The photo-analyzer 14 then sends 44 data regarding the determined characteristics to the printer 22 which then prints 46 the body fluid source identifying information and/or determined characteristics onto the surface of the container 18, using alpha-numeric lettering and/or bar code form. The printer 22 may print the body fluid source identifying information and determined characteristics on a printable surface of the container 18, or a label 26 placed on the container 18, using alpha-numeric lettering and/or bar code form. If the container 18 includes an RFID inlet 28, the photo analyzer 14 sends 45 data regarding the determined characteristics to the RFID reader 34. The determined characteristics data may then be ‘written’ or transmitted 47 to the RFID inlet 28 on the container 18. Data identifying the source of the blood may also be transmitted 47 to the container 18 via RFID technology. Any commercially available RFID chip may be used, including, for example, Hitachi Corporation's mu-chip which is wireless accessible at 2.4-2.45 GHz, can store up to 128 bits of data, and at 0.4 mm square is thin enough to be embedded in a label attached to the sample container or within a part of the container itself. An antenna for receiving incoming data is connected to the RFID chip.

It is well known to those skilled in the art that RFID circuitry of the type under discussion is provided in a plurality of configurations; for example, read only, read/write, passive, and active. The read only provides previously installed information from the RFID circuit through a compatible reader. The read/write circuit permits the reader to install or alter information stored in the circuit. The passive circuit is one which depends for activation and operating power upon the signal emitted by the reader while the active circuit includes a battery or other internal power source which may be activated by the signal from the reader.

The carrier unit 12 may be powered by an outside source (e.g., a power cord connects the unit 12 to a wall socket or the like) or by a battery located within the unit 12 that is electrically connected to sub-systems, such as the photo-analyzer 14 and/or the printer 22. The battery may be a rechargeable battery that is rechargeable while still within the unit 12 by connecting the unit 12 to an outside power source.

Alternatively, the unit 12 may be connected to a personal computer, central server, handheld device, etc. either by cables, RFID or wireless technology.

In the alternative, the patient's identification information may be downloaded and/or written to a hospital central server at the time the patient is checking in at the hospital admittance station. The hospital central server may contain a data base of all fingerprints and identification information of every patient admitted to the hospital where that patient's identification information has been entered into the hospital server. This hospital central server could be linked with other hospitals, city or nationwide, to share identification data with other medical facilities in order to prevent fraud, identity theft, drug abuse, etc. In this situation, the fingerprint data file stored on a patient's RFID wristband is also stored in the hospital's central server so that the information may be referred to at a later time. This provides the benefit of an additional layer of security to the hospital. For example, county hospitals may face a security issue where unscrupulous people utilize the hospital as a source of drugs for their benefit. These people may provide different identification during different visits in order to be able to obtain drugs for whatever ailment they may be currently feigning. This can cost hospitals vast sums of money as there is no method of cross-checking the various identities these people may provide at check-in. Software within the check-in computer used at the hospital admittance desk would allow the check-in computer to communicate with the hospital's central server. This software would allow the fingerprint minutia data to be sent to the hospital server so that the data could be compared to all the other people who have been entered into the system. For example, a person may come into the hospital and provides his/her identification information. The patient has a fingerprint read and stored in the hospital system. The patient is then treated for his ailment. If, for example, a few days later, the same person arrives at the hospital again, the system will be able to check for a disparity between the identification submitted in the past and present since both sets of identification will be associated with the same fingerprints. When the patient goes to the check-in station and provides the identification, the check-in computer will send that new data to the server. If the identification sent to the server matches information already stored on the server, a patient wristband will be provided to that person checking in. However, if the identification the person provides does not match the identification already associated with the fingerprint stored on the server, the hospital will act accordingly. In the alternative, an additional layer of security could be added by including a photo identification of a patient. This photo could be taken by a digital camera and the information then stored within the hospital central server. The photo could also be printed on the patient's RFID wristband. This would provide an additional layer of security, as well as display the patient's photo on the wristband for additional visual identification. This would further facilitate identification at the check-in station as the stored photo could be visually compared to the person whose fingerprint is currently being read. This would also allow the digital photo to be displayed on the display built into the user interface 33 of the carrier unit 12. The display on the carrier unit 12 would allow the patient's identification information to be displayed as well as the patient's digital photo. This would provide a further visual identification and therefore additional security.

In another alternative, networking capabilities could be added to the carrier unit 12 that would allow it to use an always-on wireless method in order to enable the carrier unit 12 to be in constant communication with the hospital's central server.

While the system 10 of the present invention has been described in a hospital or medical setting, applications are possible in other settings. For example, the present invention is also applicable in business settings, law enforcement settings, field paramedical settings, or home settings where identification of the characteristics of a bodily fluid is combined with the need to match the sample with its source and to identify the source and/or the characteristics of the sample on the sample container.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

1. A process for analyzing a body fluid, comprising the steps of:
placing a sample of the body fluid in a container;
placing the container in a fluid analyzing unit;
analyzing the sample to determine characteristics of the body fluid; and
transferring the determined characteristics to the container.

2. The process of claim 1, wherein the transferring step includes the step of placing the determined characteristics on a label.

3. The process of claim 2, including the step of affixing the label to the container.

4. The process of claim 1, wherein the transferring step includes the steps of communicating body fluid source identifying data to the fluid analyzing unit, and printing the body fluid source identifying data on the container.

5. The process of claim 4, wherein the printing step includes the step of printing the body fluid source identifying data onto a label.

6. The process of claim 5, wherein the transferring step includes the step of printing the determined characteristics on the label.

7. The process of claim 5, including the step of-affixing the label to the container.

8. The process of claim 4, wherein the transferring step includes the step of communicating the body fluid source identifying data to a radio frequency identification (RFID) inlet associated with the container.

9. The process of claim 8, wherein the container includes a label having the RFID inlet.

10. The process of claim 9, wherein the transferring step includes the step of printing the determined characteristics on the label.

11. The process of claim 10, including the step of affixing the label to the container.

12. The process of claim 8, wherein the transferring step includes the step of communicating the determined characteristics to the RFID inlet.

13. The process of claim 4, wherein the transferring step includes the step of communicating the body fluid source identifying data to the container via a barcode printer.

14. The process of claim 13, wherein the step of communicating the body fluid source identifying data includes the step of printing a barcode onto a label.

15. The process of claim 14, including the step of affixing the label to the container.

16. The process of claim 13, wherein the transferring step includes the step of communicating the determined characteristics to the container via the barcode printer.

17. The process of claim 16, wherein the step of communicating the determined characteristics includes the step of printing a barcode onto a label.

18. The process of claim 17, including the step of affixing the label to the container.

19. The process of claim 1, wherein the determined characteristics include at least one of the following: blood type and Rh factor.

20. A process for analyzing a body fluid, comprising the steps of:
placing a sample of the body fluid in a container;
placing the container in a fluid analyzing unit;
analyzing the sample to determine characteristics of the body fluid;
transferring the determined characteristics to the container; and
communicating body fluid source identifying data to a radio frequency identification (RFID) inlet associated with the container.

21. The process of claim 20, wherein the container includes a label having the RFID inlet.

22. The process of claim 21, wherein the transferring step includes the step of printing the determined characteristics on the label.

23. The process of claim 22, including the step of affixing the label to the container.

24. The process of claim 20, wherein the transferring step includes the step of communicating the determined characteristics to the RFID inlet.

25. The process of claim 20, wherein the transferring step includes the step of placing the determined characteristics on a label.

26. The process of claim 25, wherein the transferring step includes the steps of communicating the body fluid source identifying data to the fluid analyzing unit, and printing the body fluid source identifying data on the container.

27. The process of claim 26, wherein the printing step includes the step of printing the body fluid source identifying data onto the label.

28. The process of claim 27, wherein the transferring step includes the step of printing the determined characteristics on the label.

29. The process of claim 20, wherein the transferring step includes the steps of communicating the body fluid source identifying data to the fluid analyzing unit, printing the bodyfluid source identifying data on the container, and communicating the body fluid source identifying data to the container via a barcode printer.

30. The process of claim 29, wherein the step of communicating the body fluid source identifying data includes the step of printing a barcode onto a label.

31. A process for analyzing a body fluid, comprising the steps of:
placing the container in a fluid analyzing unit;
placing a sample of the body fluid in a container;
communicating body fluid source identifying data to the fluid analyzing unit;
printing the body fluid source identifying data on the container;
analyzing the sample to determine characteristics of the body fluid;
transferring the determined characteristics to the container;
communicating the body fluid source identifying data to a radio frequency identification (RFID) inlet associated with the container; and
communicating the determined characteristics to the RFID inlet

32. The process of claim 31, including the step of printing the body fluid source identifying data onto a label;

33. The process of claim 32, including the step of affixing the label to the container.

34. The process of claim 33, wherein the label includes the RFID inlet.

35. The process of claim 34, wherein the transferring step includes the step of printing the determined characteristics on the label.

36. The process of claim 32, wherein the step of communicating the determined characteristics includes the step of printing a barcode onto the label.
